(19) United States
(12) Patent Application Publication
(10) Pub. No.: US 2022/0271696 A1
(43) Pub. Date: Aug. 25, 2022

(54) SYSTEM AND METHOD FOR CONTROLLING MOTOR PARAMETERS, AND STORAGE MEDIUM

(71) Applicant: AAC Acousitc Technologies (Shanghai)Co., Ltd., Shanghai (CN)

(72) Inventors: Zheng Xiang, Shenzhen (CN); Xiang Lu, Shenzhen (CN); Hanlin Deng, Shenzhen (CN); Liang Jiang, Shenzhen (CN)

(21) Appl. No.: 17/668,396

(22) Filed: Feb. 10, 2022

Related U.S. Application Data
(63) Continuation-in-part of application No. 16/527,058, filed on Jul. 31, 2019, now abandoned.

(30) Foreign Application Priority Data
Aug. 13, 2018 (CN) 201810918771.7

(51) Int. Cl. H02P 23/00; H02P 25/034; H02P 25/06; H02P 23/14

(52) U.S. Cl. CPC H02P 23/0077; H02P 25/034; H02P 25/06; H02P 23/14; H02P 23/0022

(57) ABSTRACT

The present disclosure provides a system and a method for controlling motor parameters. The system includes a feedforward processing module performing a linear processing on a control signal according to parameters; a control object module including a DAC digital to analog converter, an amplifying circuit and an ADC analog to digital converter, a control signal processed by the feedforward processing module passing through the DAC digital to analog converter, and amplified by the amplifier circuit, and passing through the ADC analog to digital converter to obtain a voltage ν_{c·m}[n] and a current i_{c·m}[n] across the motor; a system identification module including an LMS adaptive filter, a Least mean square filtering performed on an error signal εₒₑᵢ[n] between a measured current i_{c·m}[n] and a prediction current i_{c·p}[n], results of iteration feed back to the feedforward processing module, and the feedback results applied to the next data acquisitions and parameters calculations.

### CROSS-REFERENCE TO RELATED APPLICATIONS

The present application is a continuation in part of U.S. application Ser. No. 16/527,058 filed on Jul. 31, 2019, which claims priority to Chinese Application No. 201810918771.7, filed on Aug. 13, 2018, the contents of both of which are incorporated herein by reference in their entireties.

### TECHNICAL FIELD

The present disclosure relates to microelectromechanical field, more particularly to a system and a method for controlling motor parameters, and a non-transitory storage medium.

### BACKGROUND

As Linear Resonator Actuators (LRA) become more and more popular in the field of smart phones and tablet computers, etc., how to effectively control motor vibrations becomes very important. In traditional control method, motor excitation signals are controlled by presetting motor parameters, and it's commonly known as open loop control technology. The technology is simple to implement and does not require complicated control theories, but it cannot adaptively adjust according to differences of motor batches and individuals, meanwhile, cannot effectively track parameters variation caused by the change of motor temperature and attitude, and so on.

Therefore, it is necessary to provide a new system and method for controlling motor parameters to solve the above problems.

### SUMMARY

The present disclosure provides a method for driving a motor, applied to an electronic device, comprising: obtaining, by a processor, a control signal of the electronic device; performing, by the processor, linear processing on the control signal to obtain a processed control signal; converting, by a digital to analog converter (DAC), the processed control signal to obtain a converted control signal; amplifying, by an amplifier circuit, the converted control signal to obtain an amplified control signal; converting, by an analog to digital converter (ADC), the amplified control signal to obtain voltage ν_{c·m}[n] and a current i_{c·m}[n] to be applied to two ends the motor; obtaining, by the processor, an error signal εₒₑᵢ[n] representing a difference between the current i_{c·m}[n] and a prediction current i_{c·p}[n]; filtering, by a least mean square (LMS) adaptive filter, the obtained error signal εₒₑᵢ[n] to obtain a filtered result; and processing, by the processor, the filtered result and real-time adjusting parameters of the motor.

The prediction current i_{c·p}[n] is calculated based on:

$${i}_{c \cdot p} [ n ] = \frac{1}{{R}_{e b}} ( {v}_{c \cdot m} [ n ] - ϕ ( {x}_{d} [ n ] ) {u}_{d} [ n ] ) ,$$

where R_{eb} is a resistance of a coil of the motor, ϕ(x_{d}[n]) is an electromagnetic force coefficient which is a function of x_{d}[n], x_{d}[n] is a mechanical displacement of an oscillator of the motor, u_{d}[n] is a mechanical velocity of the oscillator of the motor, ϕ(x_{d}[n]) is a constant satisfying ϕ(x_{d}[n])≈ϕ₀,
in a second-order model x_{d}[n]=σₓf_{c·p}[n−1]−a₁x_{d}[n−1]−a₂x_{d}[n−2], u_{d}[n]=σᵤf_{c·p}[n]−σᵤf_{c·p}[n−2]−a₁u_{d}[n−1]−a₂u_{d}[n−2], where σₓ, σᵤ, a₁ and a₂ are parameters of the second-order model, f_{c·p}[n] is electromagnetic force, f_{c·p}[n]=ϕ(x_{d}[n])i_{c·m}[n]−k₁(x_{d}[n])x_{d}[n], k₁(x_{d}[n])≈0, and
an error function of the error signal εₒₑᵢ[n] is expressed by:

$$\begin{matrix}{ε}_{oei} [ n ] = {i}_{c \cdot m} [ n ] - {i}_{c \cdot p} [ n ] \\ = {i}_{c \cdot m} [ n ] - \frac{1}{{R}_{e b}} ( {v}_{c \cdot m} [ n ] - {ϕ}_{0} ( {σ}_{u} {ϕ}_{0} ( {i}_{c \cdot m} [ n ] - {i}_{c \cdot m} [ n - 2 ] ) - \\ {a}_{1} {u}_{d} [ n - 1 ] - {a}_{2} {u}_{d} [ n - 2 ] ) ) .\end{matrix}$$

In an embodiment, the R_{eb} satisfies:

$${R}_{e b} [ n + 1 ] = {R}_{e b} [ n ] - {μ}_{{R}_{eb}} {ε}_{oei} [ n ] \frac{{i}_{c \cdot p} [ n ]}{{R}_{e b} [ n ]} .$$

In an embodiment, a feedback coefficient aₖ of the LMS adaptive filter satisfies:

$${a}_{k} [ n + 1 ] = {a}_{k} [ n ] - {μ}_{{a}_{k}} {ε}_{oei} [ n ] \frac{{ϕ}_{0} [ n ]}{{R}_{e b} [ n ]} {α}_{k} [ n ] , \\ where$$

$${α}_{k} [ n ] = - {u}_{d} [ n - k ] - {a}_{1} [ n ] {α}_{k} [ n - 1 ] - {a}_{2} [ n ] {α}_{k} [ n - 2 ] .$$

In an embodiment, a feedforward coefficient σᵤ of the LMS adaptive filter satisfies:

$${σ}_{u} [ n + 1 ] = {σ}_{u} [ n ] - {μ}_{{σ}_{u}} {ε}_{oei} [ n ] \frac{{ϕ}_{0} [ n ]}{{R}_{e b} [ n ]} {β}_{{σ}_{u}} [ n ] .$$

In an embodiment, the electromagnetic force coefficient ϕ₀ satisfies:

$${ϕ}_{0} [ n + 1 ] = {ϕ}_{0} [ n ] - {μ}_{{ϕ}_{0}} {ε}_{o e i} [ n ] ( \frac{1}{{R}_{e b} [ n ]} {u}_{d} [ n ] + \frac{{ϕ}_{0} [ n ]}{{R}_{e b} [ n ]} {\partial }_{ϕ u} [ n ] ) , \\ where$$

$${\partial }_{ϕ u} [ n ] = {σ}_{u} ( {i}_{c \cdot m} [ n ] - {i}_{c \cdot m} [ n - 2 ] ) - {a}_{1} [ n ] {\partial }_{ϕ u} [ n - 1 ] - {a}_{2} [ n ] {\partial }_{ϕ u} [ n - 2 ] .$$

The present disclosure further provides a system for driving a motor of an electronic device, comprising: at least one processor, and a memory configured to store instructions executable by the at least one processor. The instructions cause the at least one processor to perform the method steps as described above.

The present disclosure further provides a non-transitory computer-readable storage medium. The computer-readable storage medium stores computer program instructions thereon, the computer program instructions, when being executed by a processor, are configured to perform the method steps as described above.

### BRIEF DESCRIPTION OF DRAWINGS

FIG. 1 is a schematic view of a system for controlling motor parameters according to the present disclosure.

FIG. 2 is a schematic view showing hardware structure according to the present disclosure.

### DESCRIPTION OF EMBODIMENTS

Hereafter, the present disclosure will be further described with reference to the accompanying drawings and embodiments.

A system for controlling motor parameters of the present disclosure is applied to linear motors equipped in electronic devices such as smart phones or tablet computers, which can dynamically track the motor parameters by simply detecting feedback signals.

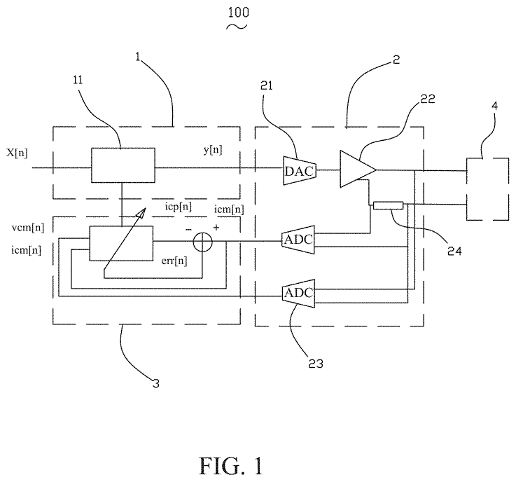

As shown in FIG. 1, the system for controlling motor parameters 100 of the present disclosure comprises a feedforward processing module 1, a control object module 2 and a system identification module 3.

The feedforward processing module 1 has a linear processing unit 11. The feedforward processing unit 11 preforms a linear processing on a control signal according to parameters. The control signal can be obtained from a processing chip of the electronic device. Specifically, the linear processing comprises filtering and equalization processing methods, etc., so that the control signal x[n] is processed by the module to obtain y[n].

The control object module 2 comprises a DAC digital to analog converter 21, an amplifying circuit 22 and at least one ADC analog to digital converter 23. The control signal processed by the feedforward processing module 1 passes through the DAC digital to analog converter 21, and then is amplified by the amplifier circuit 22, and then passes through the ADC analog to digital converter 23 to obtain a voltage ν_{c·m}[n] and a current i_{c·m}[n] across the motor 4. The current is obtained via a high sensitive resistance 24 having a small resistance value, the resistance 24 is connected with the motor 4 in series.

The system identification module 3 comprises a LMS (Least mean square) adaptive filter. A Least mean square filtering is performed on an error signal εₒₑᵢ[n] between a measured current i_{c·m}[n] and a prediction current i_{c·p}[n] in the LMS adaptive filter. The results of iteration are fed back to the feedforward processing module 1, and the feedback results are applied to the next data acquisitions and parameters calculations.

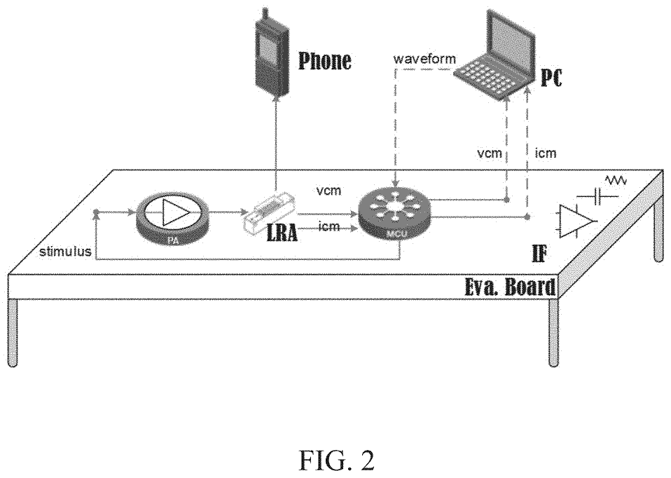

It is appreciated that, the modules described above, such as the feedforward processing module and the system identification module may be implemented in processors such as a Microprogrammed Control Unit (MCU) or a Digital Signal Processor (DSP). The acquired data can be simultaneously displayed and analyzed by for example a PC, and the PC can also transmit instructions such as waveforms down to the processors described above. FIG. 2 is schematic view showing hardware structure according to the present disclosure.

The present disclosure further provides a method using the above-mentioned system for controlling motor parameters. The method disclosed in the present disclosure mainly comprises the following steps:

step S1: a model for parameters of a vibration motor is modeled;

step S2: the parameters in the vibration motor model is estimated.

After modelling the model for parameters of the vibration motor in step S1, the following expression can be obtained:

an expression of the prediction current i_{c·p}[n] is:

$${i}_{c \cdot p} [ n ] = \frac{1}{{R}_{e b}} ( {v}_{c \cdot m} [ n ] - ϕ ( {x}_{d} [ n ] ) {u}_{d} [ n ] ) , \qquad ( 1 )$$

where, Reb is a resistance of a voice coil of the motor; ϕ(x_{d}[n]) is an electromagnetic force coefficient which is a function of mechanical displacement of an x_{d}[n] u_{d}[n] oscillator x_{d}[n] u_{d}[n] is a mechanical velocity of the oscillator, i.e., a product of an electromagnetic force and the velocity of the oscillator, Vc−m[n] is a back electromotive force brought to the electric circuit by the mechanical motion.

classical second-order models are modeled for both the displacement x_{d}[n] and the velocity u_{d}[n], and the expressions are as follows:

$${x}_{d} [ n ] = {σ}_{x} {f}_{c \cdot p} [ n - 1 ] - {a}_{1} {x}_{d} [ n - 1 ] - {a}_{2} {x}_{d} [ n - 2 ] ; \qquad ( 2 )$$

$${u}_{d} [ n ] = {σ}_{u} {f}_{c \cdot p} [ n ] - {σ}_{u} {f}_{c \cdot p} [ n - 2 ] - {a}_{1} {u}_{d} [ n - 1 ] - {a}_{2} {u}_{d} [ n - 2 ] , \qquad ( 3 )$$

where, σₓ, σᵤ and a₁, a₂ are parameters of the second-order model, and f_{c·p}[n] is the electromagnetic force.

The expression of the electromagnetic force f_{c·p}[n] is:

$${f}_{c \cdot p} [ n ] = ϕ ( {x}_{d} [ n ] ) {i}_{c \cdot m} [ n ] - {k}_{1} ( {x}_{d} [ n ] ) {x}_{d} [ n ] , \qquad ( 4 )$$

where, k1 is a nonlinear portion of a stiffness coefficient k; in the case of linear parameters, the nonlinear term of the stiffness coefficient is 0, k₁(x_{d}[n])≈0.

As seen from the formula (2) and formula (3), although a mutual calculation relationship exists between the displacement x_{d}[n] and the electromagnetic force f_{c·p}[n], the displacement x_{d}[n] of this moment n is calculated from the electromagnetic force f_{c·p}[n−1] of the previous moment [n−1] in the formula (2), and in the formula (3), from the displacement x_{d}[n] to the electromagnetic force f_{c·p}[n], there are no memory.

In the case of barely considering the linear parameters, the above formulas can be simplified as follows:

1. the electromagnetic force coefficient ϕ(x_{d}[n]) is a constant, that is, ϕ(x_{d}[n])≈ϕ₀, and ϕ(x_{d}[n])=ϕ₀ can be obtained;

2. the nonlinear term of the stiffness coefficient is 0, that is, k₁(x_{d}[n])≈0, and k₁(x_{d}[n])=0 can be obtained;

3. there is no need to calculate the displacement x_{d}[n], that is, there is no need to perform an adaptive iteration calculation to σₓ in formula (2).

Therefore, an expression of an error function is:

$$\begin{matrix}{ε}_{oei} [ n ] = {i}_{c \cdot m} [ n ] - {i}_{c \cdot p} [ n ] \\ = {i}_{c \cdot m} [ n ] - \frac{1}{{R}_{e b}} ( {v}_{c \cdot m} [ n ] - {ϕ}_{0} ( {σ}_{u} {ϕ}_{0} ( {i}_{c \cdot m} [ n ] - {i}_{c \cdot m} [ n - 2 ] ) - \\ {a}_{1} {u}_{d} [ n - 1 ] - {a}_{2} {u}_{d} [ n - 2 ] ) ) .\end{matrix} \qquad ( 5 )$$

As to the step S2, wherein the parameters in the vibrating motor model are estimated, in the present disclosure, a classical LMS algorithm (Least mean square) is used to estimate each parameter in the formula (5), a partial derivative of each parameter is used as an update amount, and the parameter iteration is performed point by point.

Details are as follows:

resistance of the motor R_{eb},

$${R}_{e b} [ n + 1 ] = {R}_{e b} [ n ] - {μ}_{{R}_{eb}} {ε}_{oei} [ n ] \frac{{i}_{c \cdot p} [ n ]}{{R}_{e b} [ n ]} ; \qquad ( 6 )$$

IIR filter feedback coefficient aₖ,

$${a}_{k} [ n + 1 ] = {a}_{k} [ n ] - {μ}_{{a}_{k}} {E}_{oei} [ n ] \frac{{ϕ}_{0} [ n ]}{{R}_{e b} [ n ]} {α}_{k} [ n ] ; \\ where , \qquad ( 7 )$$

$${α}_{k} [ n ] = - {u}_{d} [ n - k ] - {a}_{1} [ n ] {α}_{k} [ n - 1 ] - {a}_{2} [ n ] {α}_{k} [ n - 2 ] ; \qquad ( 8 )$$

IIR filter forward coefficient σᵤ,

$${σ}_{u} [ n + 1 ] = {σ}_{u} [ n ] - {μ}_{{σ}_{u}} {ε}_{oei} [ n ] \frac{{ϕ}_{0} [ n ]}{{R}_{e b} [ n ]} {β}_{{σ}_{u}} [ n ] ; where , \qquad ( 9 )$$

$${β}_{{σ}_{u}} [ n ] = {f}_{c \cdot p} [ n ] - {f}_{c \cdot p} [ n - 2 ] - {a}_{1} [ n ] {β}_{{σ}_{u}} [ n - 1 ] - {a}_{2} [ n ] {β}_{{σ}_{u}} [ n - 2 ] ; \qquad ( 10 )$$

electromagnetic force coefficient ϕ₀,

$${ϕ}_{0} [ n + 1 ] = {ϕ}_{0} [ n ] - {μ}_{{ϕ}_{0}} {ε}_{oei} [ n ] ( \frac{1}{{R}_{e b} [ n ]} {u}_{d} [ n ] + \frac{{ϕ}_{0} [ n ]}{{R}_{e b} [ n ]} {\partial }_{ϕ u} [ n ] ) ; \\ where , \qquad ( 11 )$$

$${\partial }_{ϕ u} [ n ] = {σ}_{u} ( {i}_{c \cdot m} [ n ] - {i}_{c \cdot m} [ n - 2 ] ) - {a}_{1} [ n ] {\partial }_{ϕ u} [ n - 1 ] - {a}_{2} [ n ] {\partial }_{ϕ u} [ n - 2 ] . \qquad ( 12 )$$

Furthermore, in order to make the LMS iteration robuster, the sample-by-sample LMS calculation can be replaced by a frame-by-frame LMS calculation.

Compared with the related art, the present disclosure provides a system and a method for controlling motor parameters, wherein the system includes a feedforward processing module performing a linear processing on a control signal according to parameters; a control object module comprising a DAC digital to analog converter, an amplifying circuit and an ADC analog to digital converter. Wherein a control signal processed by the feedforward processing module passes through the DAC digital to analog converter, and is amplified by the amplifier circuit, and then the control signal passes through the ADC analog to digital converter to obtain a voltage ν_{c·m}[n] and a current i_{c·m}[n] across the motor. A system identification module comprises a LMS adaptive filter, wherein a Least mean square filtering is performed on an error signal εₒₑᵢ[n] between a measured current i_{c·m}[n] and a prediction current i_{c·p}[n] in the LMS adaptive filter, results of iteration are fed back to the feedforward processing module, and feedback results are applied to the next data acquisitions and parameters calculations. The system for controlling motor parameters provided by the present disclosure can solve common difficulties in actual measurement operation, can simplify the steps, facilitate the measurement and ensure the accuracy of the measurement.

The present disclosure may be implemented as a system, method and/or computer program product. The computer program product may include a computer-readable storage medium having computer-readable program instructions loaded thereon for causing a processor to implement various aspects of the present disclosure.

A computer-readable storage medium may be a tangible device that can hold and store instructions for use by the instruction execution device. The computer-readable storage medium may be, for example, but not limited to, an electrical storage device, a magnetic storage device, an optical storage device, an electromagnetic storage device, a semiconductor storage device, or any suitable combination of the foregoing. More specific examples (non-exhaustive list) of computer readable storage media include: portable computer disks, hard disks, random access memory (RAM), read only memory (ROM), erasable programmable read only memory (EPROM) or flash memory), static random access memory (SRAM), portable compact disk read only memory (CD-ROM), digital versatile disk (DVD), memory sticks, floppy disks, mechanically coded devices, such as printers with instructions stored thereon punched cards or raised structures in grooves, and any suitable combination of the above. Computer-readable storage media, as used herein, are not to be construed as transient signals per se, such as radio waves or other freely propagating electromagnetic waves, electromagnetic waves propagating through waveguides or other transmission media (e.g., light pulses through fiber optic cables), or through electrical wires transmitted electrical signals.

The computer readable program instructions described herein may be downloaded to various computing/processing devices from a computer readable storage medium, or to an external computer or external storage device over a network such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

Computer program instructions for carrying out operations of the present disclosure may be assembly instructions, instruction set architecture (ISA) instructions, machine instructions, machine-dependent instructions, microcode, firmware instructions, state setting data, or instructions in one or more programming languages. Source or object code, written in any combination, including object-oriented programming languages, such as Smalltalk, C++, etc., and conventional procedural programming languages, such as the “C” language or similar programming languages. The computer readable program instructions may execute entirely on the user's computer, partly on the user's computer, as a stand-alone software package, partly on the user's computer and partly on a remote computer, or entirely on the remote computer or server implement. In the case of a remote computer, the remote computer may be connected to the user's computer through any kind of network, including a local area network (LAN) or a wide area network (WAN), or may be connected to an external computer (e.g., using an Internet service provider through the Internet connect). In some embodiments, custom electronic circuits, such as programmable logic circuits, field programmable gate arrays (FPGAs), or programmable logic arrays (PLAs), can be personalized by utilizing state information of computer readable program instructions. Computer readable program instructions are executed to implement various aspects of the present disclosure.

Aspects of the present disclosure are described herein with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer readable program instructions.

The above are only the embodiments of the present disclosure, but not limit to the patent scope of the present disclosure, and equivalent structures or equivalent process transformations made by utilizing the present disclosure and the contents of the drawings, or directly or indirectly applied to other related technical fields, are all included in the scope of the patent protection of the present disclosure.

What is claimed is:

1. A method for driving a motor, applied to an electronic device, comprising:
obtaining, by a processor, a control signal of the electronic device;
performing, by the processor, linear processing on the control signal to obtain a processed control signal;
converting, by a digital to analog converter (DAC), the processed control signal to obtain a converted control signal;
amplifying, by an amplifier circuit, the converted control signal to obtain an amplified control signal;
converting, by an analog to digital converter (ADC), the amplified control signal to obtain voltage ν_{c·m}[n] and a current i_{c·m}[n] to be applied to two ends the motor;
obtaining, by the processor, an error signal εₒₑᵢ[n] representing a difference between the current i_{c·m}[n] and a prediction current i_{c·p}[n];
filtering, by a least mean square (LMS) adaptive filter, the obtained error signal εₒₑᵢ[n] to obtain a filtered result; and
processing, by the processor, the filtered result and real-time adjusting parameters of the motor;
wherein the prediction current i_{c·p}[n] is calculated based on:
$${i}_{c \cdot p} [ n ] = \frac{1}{{R}_{e b}} ( {v}_{c \cdot m} [ n ] - ϕ ( {x}_{d} [ n ] ) {u}_{d} [ n ] ) ,$$
where R_{eb} is a resistance of a coil of the motor, ϕ(x_{d}[n]) is an electromagnetic force coefficient which is a function of x_{d}[n], x_{d}[n] is a mechanical displacement of an oscillator of the motor, u_{d}[n] is a mechanical velocity of the oscillator of the motor, ϕ(x_{d}[n]) is a constant satisfying ϕ(x_{d}[n])≈ϕ₀,
in a second-order model x_{d}[n]=σₓf_{c·p}[n−1]−a₁x_{d}[n−1]−a₂x_{d}[n−2], u_{d}[n]=σᵤ f_{c·p}[n]−σᵤf_{c·p}[n−2]−a₁u_{d}[n−1]−a₂u_{d}[n−2], where σₓ, σᵤ, a₁ and a₂ are parameters of the second-order model, f_{c·p}[n] is electromagnetic force, f_{c·p}[n]=ϕ(x_{d}[n])i_{c·m}[n]−k₁(x_{d}[n])x_{d}[n], k₁(x_{d}[n])≈0, and
an error function of the error signal Eₒₑᵢ[n] is expressed by:
$$\begin{matrix}{ε}_{oei} [ n ] = {i}_{c \cdot m} [ n ] - {i}_{c \cdot p} [ n ] \\ = {i}_{c \cdot m} [ n ] - \frac{1}{{R}_{e b}} ( {v}_{c \cdot m} [ n ] - {ϕ}_{0} ( {σ}_{u} {ϕ}_{0} ( {i}_{c \cdot m} [ n ] - \\ {i}_{c \cdot m} [ n - 2 ] ) - {a}_{1} {u}_{d} [ n - 1 ] - {a}_{2} {u}_{d} [ n - 2 ] ) ) .\end{matrix}$$

2. The method according to claim 1, wherein the R_{eb} satisfies:
$${R}_{e b} [ n + 1 ] = {R}_{e b} [ n ] - {μ}_{{R}_{eb}} {ε}_{oei} [ n ] \frac{{i}_{c \cdot p} [ n ]}{{R}_{e b} [ n ]} .$$

3. The method according to claim 1, wherein a feedback coefficient aₖ of the LMS adaptive filter satisfies:
$${a}_{k} [ n + 1 ] = {a}_{k} [ n ] - {μ}_{{a}_{k}} {ε}_{oei} [ n ] \frac{{ϕ}_{0} [ n ]}{{R}_{e b} [ n ]} {α}_{k} [ n ] , \\ where \\ {α}_{k} [ n ] = - {u}_{d} [ n - k ] - {a}_{1} [ n ] {α}_{k} [ n - 1 ] - {a}_{2} [ n ] {α}_{k} [ n - 2 ] .$$

4. The method according to claim 1, wherein a feedforward coefficient σᵤ of the LMS adaptive filter satisfies:
$${σ}_{u} [ n + 1 ] = {σ}_{u} [ n ] - {μ}_{{σ}_{u}} {ε}_{oei} [ n ] \frac{{ϕ}_{0} [ n ]}{{R}_{e b} [ n ]} {β}_{{σ}_{u}} [ n ] .$$

5. The method according to claim 1, wherein the electromagnetic force coefficient ϕ₀ satisfies:
$${ϕ}_{0} [ n + 1 ] = {ϕ}_{0} [ n ] - {μ}_{{ϕ}_{0}} {ε}_{oei} [ n ] ( \frac{1}{{R}_{e b} [ n ]} {u}_{d} [ n ] + \frac{{ϕ}_{0} [ n ]}{{R}_{e b} [ n ]} {\partial }_{ϕ u} [ n ] ) , \\ where \\ {\partial }_{ϕ u} [ n ] = {σ}_{u} ( {i}_{c \cdot m} [ n ] - {i}_{c \cdot m} [ n - 2 ] ) - {a}_{1} [ n ] {\partial }_{ϕ u} [ n - 1 ] - {a}_{2} [ n ] {\partial }_{ϕ u} [ n - 2 ] .$$

6. A system for driving a motor of an electronic device, comprising:
at least one processor, and
a memory configured to store instructions executable by the at least one processor;
wherein the instructions cause the at least one processor to:
obtain a control signal of the electronic device;
perform linear processing on the control signal to obtain a processed control signal;
convert the processed control signal to obtain a converted control signal;
amplify the converted control signal to obtain an amplified control signal;
convert the amplified control signal to obtain voltage ν_{c·m}[n] and a current i_{c·m}[n] to be applied to two ends the motor;
obtain an error signal εₒₑᵢ[n] representing a difference between the current i_{c·m}[n] and a prediction current i_{c·p}[n];
filtering the obtained error signal εₒₑᵢ to obtain a filtered result;
processing the filtered result and real-time adjusting parameters of the motor;
wherein the prediction current i_{c·p}[n] is calculated based on:
$${i}_{c \cdot p} [ n ] = \frac{1}{{R}_{e b}} ( {v}_{c \cdot m} [ n ] - ϕ ( {x}_{d} [ n ] ) {u}_{d} [ n ] ) ,$$
where R_{eb} is a resistance of a coil of the motor, ϕ(x_{d}[n]) is an electromagnetic force coefficient which is a function of x_{d}[n], x_{d}[n] is a mechanical displacement of an oscillator of the motor, u_{d}[n] is a mechanical velocity of the oscillator of the motor, ϕ(x_{d}[n]) is a constant satisfying ϕ(x_{d}[n])≈ϕ₀,
in a second-order model x_{d}[n]=σₓf_{c·p}[n−1]−a₁x_{d}[n−1]−a₂x_{d}[n−2], u_{d}[n]=σᵤf_{c·p}[n]−σᵤf_{c·p}[n−2]−a₁u_{d}[n−1]−a₂u_{d}[n−2], where σₓ, σᵤ, a₁ and a₂ are parameters of the second-order model, f_{c·p}[n] is electromagnetic force, f_{c·p}[n]=ϕ(x_{d}[n])i_{c·m}[n]−k₁(x_{d}[n])x_{d}[n], k₁(x_{d}[n])≈0, and
an error function of the error signal εₒₑᵢ[n] is expressed by:
$$\begin{matrix}{ε}_{oei} [ n ] = {i}_{c \cdot m} [ n ] - {i}_{c \cdot p} [ n ] \\ = {i}_{c \cdot m} [ n ] - \frac{1}{{R}_{e b}} ( {v}_{c \cdot m} [ n ] - {ϕ}_{0} ( {σ}_{u} {ϕ}_{0} ( {i}_{c \cdot m} [ n ] - \\ {i}_{c \cdot m} [ n - 2 ] ) - {a}_{1} {u}_{d} [ n - 1 ] - {a}_{2} {u}_{d} [ n - 2 ] ) ) .\end{matrix}$$

7. The system according to claim 6, wherein the R_{eb} satisfies:
$${R}_{e b} [ n + 1 ] = {R}_{e b} [ n ] - {μ}_{{R}_{eb}} {ε}_{oei} [ n ] \frac{{i}_{c \cdot p} [ n ]}{{R}_{e b} [ n ]} .$$

8. The system according to claim 6, wherein a feedback coefficient aₖ of the LMS adaptive filter satisfies:
$${a}_{k} [ n + 1 ] = {a}_{k} [ n ] - {μ}_{{a}_{k}} {ε}_{oei} [ n ] \frac{{ϕ}_{0} [ n ]}{{R}_{e b} [ n ]} {α}_{k} [ n ] , \\ where \\ {α}_{k} [ n ] = - {u}_{d} [ n - k ] - {a}_{1} [ n ] {α}_{k} [ n - 1 ] - {a}_{2} [ n ] {α}_{k} [ n - 2 ] .$$

9. The system according to claim 6, wherein a feedforward coefficient σᵤ of the LMS adaptive filter satisfies:
$${σ}_{u} [ n + 1 ] = {σ}_{u} [ n ] - {μ}_{{σ}_{u}} {ε}_{oei} [ n ] \frac{{ϕ}_{0} [ n ]}{{R}_{e b} [ n ]} {β}_{{σ}_{u}} [ n ] .$$

10. The system according to claim 6, wherein the electromagnetic force coefficient ϕ₀ satisfies:
$${ϕ}_{0} [ n + 1 ] = {ϕ}_{0} [ n ] - {μ}_{{ϕ}_{0}} {ε}_{oei} [ n ] ( \frac{1}{{R}_{e b} [ n ]} {u}_{d} [ n ] + \frac{{ϕ}_{0} [ n ]}{{R}_{e b} [ n ]} {\partial }_{ϕ u} [ n ] ) , \\ where \\ {\partial }_{ϕ u} [ n ] = {σ}_{u} ( {i}_{c \cdot m} [ n ] - {i}_{c \cdot m} [ n - 2 ] ) - {a}_{1} [ n ] {\partial }_{ϕ u} [ n - 1 ] - {a}_{2} [ n ] {\partial }_{ϕ u} [ n - 2 ] .$$

11. A non-transitory computer-readable storage medium, wherein the computer-readable storage medium stores computer program instructions thereon, the computer program instructions, when being executed by a processor, are configured to:
obtain a control signal of the electronic device;
perform linear processing on the control signal to obtain a processed control signal;
convert the processed control signal to obtain a converted control signal;
amplify the converted control signal to obtain an amplified control signal;
convert the amplified control signal to obtain voltage ν_{c·m}[n] and a current i_{c·m}[n] to be applied to two ends the motor;
obtain an error signal εₒₑᵢ[n] representing a difference between the current i_{c·m}[n] and a prediction current i_{c·p}[n];
filtering the obtained error signal εₒₑᵢ[n] to obtain a filtered result;
processing the filtered result and real-time adjusting parameters of the motor;
wherein the prediction current i_{c·p}[n] is calculated based on:
$${i}_{c \cdot p} [ n ] = \frac{1}{{R}_{e b}} ( {v}_{c \cdot m} [ n ] - ϕ ( {x}_{d} [ n ] ) {u}_{d} [ n ] ) ,$$
where R_{eb} is a resistance of a coil of the motor, ϕ(x_{d}[n]) is an electromagnetic force coefficient which is a function of x_{d}[n], x_{d}[n] is a mechanical displacement of an oscillator of the motor, u_{d}[n] is a mechanical velocity of the oscillator of the motor, ϕ(x_{d}[n]) is a constant satisfying ϕ(x_{d}[n])≈ϕ₀,
in a second-order model x_{d}[n]=σₓf_{c·p}[n−1]−a₁x_{d}[n−1]−a₂x_{d}[n−2], u_{d}[n]=σᵤf_{c·p}[n]−σᵤf_{c·p}[n−2]−a₁u_{d}[n−1]−a₂u_{d}[n−2], where σₓ, σᵤ, a₁ and a₂ are parameters of the second-order model, f_{c·p}[n] is electromagnetic force, f_{c·p}[n]=ϕ(x_{d}[n])i_{c·m}[n]−k₁(x_{d}[n])x_{d}[n], k₁(x_{d}[n])≈0, and
an error function of the error signal εₒₑᵢ[n] is expressed by:
$$\begin{matrix}{ε}_{oei} [ n ] = {i}_{c \cdot m} [ n ] - {i}_{c \cdot p} [ n ] \\ = {i}_{c \cdot m} [ n ] - \frac{1}{{R}_{e b}} ( {v}_{c \cdot m} [ n ] - {ϕ}_{0} ( {σ}_{u} {ϕ}_{0} ( {i}_{c \cdot m} [ n ] - \\ {i}_{c \cdot m} [ n - 2 ] ) - {a}_{1} {u}_{d} [ n - 1 ] - {a}_{2} {u}_{d} [ n - 2 ] ) ) .\end{matrix}$$
